(19) United States
(12) Patent Application Publication
(10) Pub. No.: US 2011/0225645 A1
(43) Pub. Date: Sep. 15, 2011

(54) BASIC ARCHITECTURE FOR SECURE INTERNET COMPUTERS

(76) Inventor: Frampton E. Ellis, Jasper, FL (US)

(21) Appl. No.: 13/014,201

(22) Filed: Jan. 26, 2011

Related U.S. Application Data
(60) Provisional application No. 61/282,337, filed on Jan. 26, 2010.
(60) Provisional application No. 61/282,378, filed on Jan. 29, 2010.
(60) Provisional application No. 61/282,478, filed on Feb. 17, 2010.
(60) Provisional application No. 61/282,503, filed on Feb. 22, 2010.
(60) Provisional application No. 61/282,861, filed on Apr. 12, 2010.
(60) Provisional application No. 61/344,018, filed on May 7, 2010.

(51) Int. Cl. G06F 21/00

(52) U.S. Cl. 726/11

(57) ABSTRACT

Hardware or firmware-based firewalls or other access barriers are disclosed. The firewalls or access barriers establish one or more private units disconnected from a public unit that is connected to the Internet. One or more of the private units have a connection to one or more secure non-Internet connected private networks.

This non-provisional application claims benefit of the following: U.S. Provisional Patent Application No. 61/282,337 filed Jan. 26, 2010; U.S. Provisional Patent Application No. 61/282,378 filed Jan. 29, 2010; U.S. Provisional Patent Application No. 61/282,478 filed Feb. 17, 2010; U.S. Provisional Patent Application No. 61/282,503 filed Feb. 22, 2010; U.S. Provisional Patent Application No. 61/282,861 filed Apr. 12, 2010; and U.S. Provisional Patent Application No. 61/344,018 filed May 7, 2010; and U.S. Provisional patent application Ser. No. ______ (GNC33PA), filed Jan. 24, 2011. The contents of all of these provisional patent applications are hereby incorporated by reference in their entirety.

This provisional application hereby expressly incorporates by reference in its entirety U.S. patent application Ser. No. 10/684,657 filed Oct. 15, 2003 and published as Pub. No. US 2005/0180095 A1 on Aug. 18, 2005 and U.S. patent application Ser. No. 12/292,769 filed Nov. 25, 2008 and published as Pub. No. US 2009/0200661 A1 on Aug. 13, 2009.

Also, this provisional application hereby expressly incorporates by reference in its entirety U.S. patent application Ser. No. 10/802,049 filed Mar. 17, 2004 and published as Pub. No. US 2004/0215931 A1 on Oct. 28, 2004 and U.S. patent application Ser. No. 12/292,553 filed Nov. 20, 2008 and published as Pub. No. US 2009/0168329 A1 on Jul. 2, 2009.

Finally, this provisional application hereby expressly incorporates by reference in its entirety U.S. Pat. No. 6,167,428 issued 26 Dec. 2000, U.S. Pat. No. 6,725,250 issued 20 Apr. 2004, U.S. Pat. No. 6,732,141 issued 4 May 2004, U.S. Pat. No. 7,024,449 issued 4 Apr. 2006, U.S. Pat. No. 7,035,906 issued 25 Apr. 2006, U.S. Pat. No. 7,047,275 issued 16 May 2006, U.S. Pat. No. 7,506,020 issued 17 Mar. 2009, U.S. Pat. No. 7,606,854 issued 20 Oct. 2009, U.S. Pat. No. 7,634,529 issued 15 Dec. 2009, U.S. Pat. Nos. 7,805,756 issued 28 Sep. 2010, and 7,814,233 issued 12 Oct. 2010.

Definitions and reference numerals are the same in this application as in the above incorporated '657, '769, '049 and '553 U.S. Applications, as well as in the above incorporated '428, '250, '141, '449, '906, '275, '020, '854, '529, '756, and '233 U.S. patents.

### BRIEF DESCRIPTION OF THE DRAWINGS

FIG. 1 shows any computer, such as a personal computer 1 and/or microchip 90 (and/or 501) with an inner hardware firewall 50 establishing a Private Unit 53 of the computer or microchip that is disconnected from a Public Unit 54 that is connected to the Internet 3 (and/or another, intermediate network 2). FIG. 1 also shows an example embodiment of an optional Non-Internet-connected Network 52 for local administration of the personal computer 1 and/or microchip 90 (and/or 501) and/or silicon wafer 1500 (or portion 1501, 1502, and/or 1503).

FIG. 2 shows an example embodiment of a personal computer 1 and/or microchip 90 (and/or 501) with an inner hardware firewall 50 separating a Private Unit 53 disconnected from the Internet 3 and a Public Unit 54 connected to the Internet 3, the Private Unit 53 and Public Unit 54 connected only by a hardware firewall 50a, for example in the form of a secure, out-only bus (or wire) or channel 55 (or in an alternate embodiment, a wireless connection, including radio or optical).

FIG. 3 is a similar example embodiment to that shown in FIG. 2, but with the Private Unit 53 and Public Unit 54 connected by a hardware firewall 50b example that also includes an in-only bus or channel 56 that includes a hardware input on/off switch 57 or equivalent function signal interruption mechanism, including an equivalent functioning circuit on a microchip.

FIG. 4 is a similar example embodiment to that shown in FIGS. 2 and 3, but with Private Unit 53 and Public Unit 54 connected by a firewall 50c example that also includes an output on/off switch 58 or microcircuit equivalent on the secure, out-only bus or channel 55.

FIG. 5 shows an example embodiment of any computer such as a first personal computer 1 and/or microchip 90 (and/or 501) that is connected to a second computer such as a personal computer 1 and/or microchip 90 (and/or 501), the connection between computers made with the same hardware firewall 50c example that includes the same buses or channels with on/off switches or equivalents as FIG. 4.

FIG. 6 shows an example embodiment of a personal computer 1 and/or microchip 90 (and/or 501) similar to FIGS. 23A and 23B of the '657 Application, which showed multiple firewalls 50 with progressively greater protection, but with hardware firewalls 50c, 50b, and 50a used successively from a private unit 53, to a more private unit 53¹, and to a most private unit 53², respectively.

FIGS. 7-14 are additional architectural embodiment examples of the use of hardware firewalls 50a, 50b, and 50c.

FIGS. 15-16 are copies of the cover pages of the patent applications '657 and '769 that are incorporated by reference in this application.

### DETAILED DESCRIPTION OF THE PREFERRED EMBODIMENTS

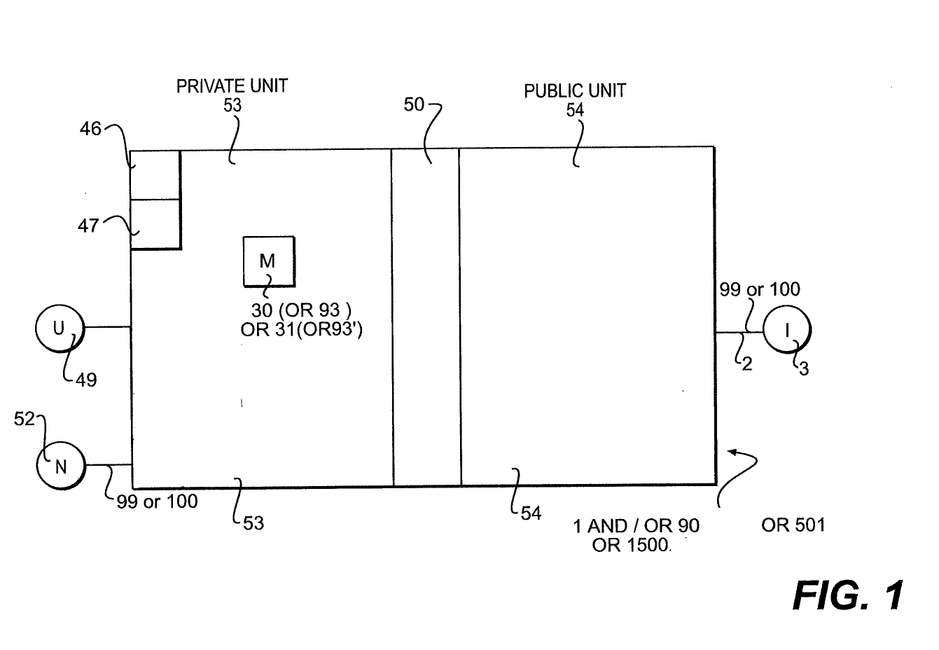

FIG. 1 shows a useful architectural example embodiment of any computer or microchip, including a personal computer 1 and/or microchip 90 (and/or 501) or silicon wafer 1500 (or portion 1501, 1502, and/or 1503) with an inner hardware-based firewall or other access barrier 50 establishing an example Private Unit 53 that is directly controlled by a user 49 (local in this example) and disconnected by hardware from a Public Unit 54 that is connected to the Internet 3 and/or another, intermediate network 2; the connection of the computer 1 (and/or 90 and/or 501) to the network 2 and/or Internet 3 can be wired 99 or wireless 100.

Hardware-based firewall or other access barrier 50 (or 50a, 50b, or 50c) as used in this application refers to a firewall or any other access barrier that includes one or more firewall or access barrier-specific hardware or firmware components; this configuration is in contrast to, for example, a computer firewall common in the art that includes only software and general purpose hardware, such as an example limited to firewall-specific software running on the general purpose microprocessor or CPU of a computer.

The Internet-disconnected Private Unit 53 includes a master controlling device 30 for the computer PC1 (and/or a master controller unit 93 for the microchip 90 and/or 501) that can include a microprocessor or processing unit and thereby take the form of a general purpose microprocessor or CPU, for one useful example, or alternatively only control the computer as a master controller 31 or master controller unit 93′. The user 49 controls the master controlling device 30 (or 31 or 93 or 93′) located in the Private Unit 53 and controls both the Private Unit 53 at all times and any part or all of the Public Unit 54 selectively, but can peremptorily control any and all parts of the Public Unit 54 at the discretion of the user 49 through active intervention or selection from a range of settings, or based on standard control settings by default.

More particularly, FIG. 1 shows a useful example of an optional (one or more) non-Internet-connected network 52 for local administration of the Private Unit 53. Wired 99 connection offers superior security generally, but wireless 100 connection is a option, especially if used with a sufficiently high level of encryption and/or other security measures, including low power radio signals of high frequency and short range and/or directional. Access from the non-Internet-connected network can be limited to only a part of the Private Unit 53 or to multiple parts or to all of the Private Unit 53.

The non-Internet-connected network 52 (not connected to the Internet either directly or indirectly, such as through another, intermediate network like an Intranet) allows specifically for use as a highly secure network for providing administrative functions like testing, maintenance, or operating or application system updates to any computers (PC1 or microchip 90 or 501) on a local network, such as a business or home network, and would be particularly useful for the example of businesses administering large numbers of local computers, such as network server arrays (especially blades) for cloud applications or supercomputer arrays with a multitude of microprocessors or local clusters. To maximize security, network 52 traffic can be encrypted and/or authenticated, especially if wireless 100.

In addition, in another useful example, a computer (PC1 and/or 90 and/or 501) can be configured so that non-Internet-connected network 52 can have the capability to allow for direct operational control of the Private Unit 53 and thus the entire computer, which can be useful for example for businesses operating an array or servers like blades or supercomputers with large numbers of microprocessors or cores.

In yet another useful example, a personal user 49 can dock his smartphone (PC1 and/or 90 and/or 501) linking to his laptop or desktop computer (PC1 and/or 90 and/or 501) in a network 52 connection to synchronize the Private Units 53 of his multiple personal computers PC1 and/or 90 and/or 501; in addition, the Public Units 54 of the user's multiple personal computers can be synchronized simultaneously; other shared operations can be performed by the linked multiple computers of the user 49 utilizing multiple Private Units 53 with one or more non-Internet connected networks 52 and multiple Public Units 54 with one or more other networks 2, including the Internet 3.

Also shown in FIG. 1 for personal computer PC1 embodiments is an optional removable memory 47 located in the Private Unit 53; the removable memory 47 can be of any form or type using any form of direct connection to the Private Unit 53; a thumbdrive or SD card are typical examples, connected to USB, Firewire, or other ports or card slots. FIG. 1 shows as well an optional removable key 46, of which an access key, an ID authentication key, or an encryption and/or decryption key are examples, also connected to the Private Unit 53 using any form of connection, including the above examples. For microchip 90 (and/or 501) embodiments, wireless connection is a feasible option to enable removable memory 47 or removable key 46, particularly for ID authentication and/or access control. In addition, all or part of the Private Unit 53 of a computer PC1 and/or microchip 90 and/or 501 can be removable from the remaining portion of the same computer PC1 and/or microchip 90 and/or 501, including the Public Unit 54.

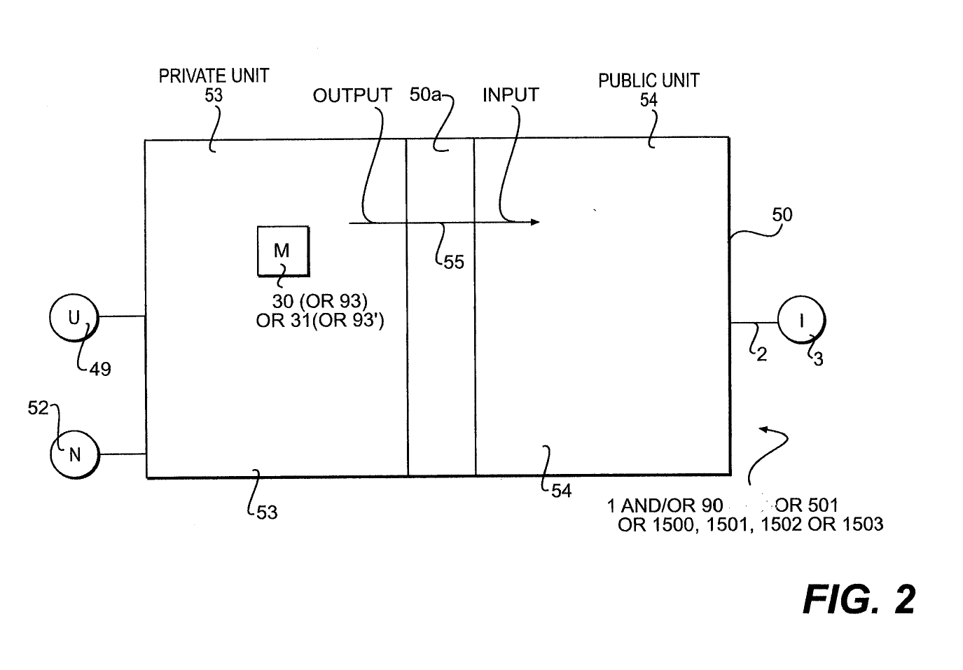

Similarly, FIG. 2 shows a useful architectural example embodiment of any computer or microchip, including a personal computer 1 and/or microchip 90 (and/or 501) with an inner hardware-based firewall or other access barrier 50 separating a Private Unit 53 that is disconnected by hardware from external networks 2 including the Internet 3 and a Public Unit 54 that is connected to external networks including the Internet 3.

In terms of communication between the two Units in the example shown in FIG. 2, the Private Unit 53 and Public Unit 54 are connected only by a firewall 50a in the form of a secure, out-only bus (or wire) or channel 55 that transmits data or code that is output from the Private Unit 53 to be input to the Public Unit 54. The user 49 controls the Private Unit 53-located master controlling device 30 (or 31 or 93 or 93′), which controls all traffic on the secure out-only bus or channel 55. Connections between the user 49 and the master controlling device 30 (or 31 or 93 or 93′), as well as between the master controlling device 30 (or 31 or 93 or 93′) and any component controlled by it, can be for example hardwired on a motherboard (and/or executed in silicon on a microchip 90 and/or 501) to provide the highest level of security.

In the example shown in FIG. 2, there is no corresponding in-only bus or channel 56 transmitting data or code that is output from the Public Unit 54 to be input to the Private Unit 53. By this absence of any bus or channel into the Private Unit 53, all access from the Internet 3 or intervening network 2 to the Private Unit 53 is completely blocked on a permanent basis. An equivalent wireless connection between the two Units would require a wireless transmitter (and no receiver) in the Private Unit 53 and a receiver (and no transmitter) in the Public Unit 54, so the Private Unit 53 can only transmit data or code to the Public Unit 54 and the Public Unit 54 can only receive data or code from the Private Unit 53 (all exclusive of external wireless transmitters or receivers of the PC1 and/or microchip 90 and/or 501).

The Private Unit 53 can include any non-volatile memory, of which read-only memory and read/write memory of which flash memory (and hard drives and optical drives) are examples, and any volatile memory, of which DRAM (dynamic random access memory) is one common example.

An equivalent connection, such as a wireless (including radio and/or optical) connection, to the out-only bus or channel 55 between the two Units 53 and 54 would require at least one wireless transmitter in the Private Unit 53 and at least one receiver in the Public Unit 54, so the Private Unit 53 can transmit data or code to the Public Unit 54 only (all exclusive of external wireless transmitters or receivers of the PC1 and/or microchip 90 and/or 501).

An architecture for any computer or microchip (or nanochip) can have any number of inner hardware-based firewalls or other access barriers 50a arranged in any configuration.

FIG. 2 also shows an example embodiment of a firewall 50 located on the periphery of the computer 1 and/or microchip 90 (and/or 501) controlling the connection between the computer and the network 2 and Internet 3; the firewall 50 can be hardwire-controlled directly by the master controlling device 30 (or 31 or 93 or 93′), for example.

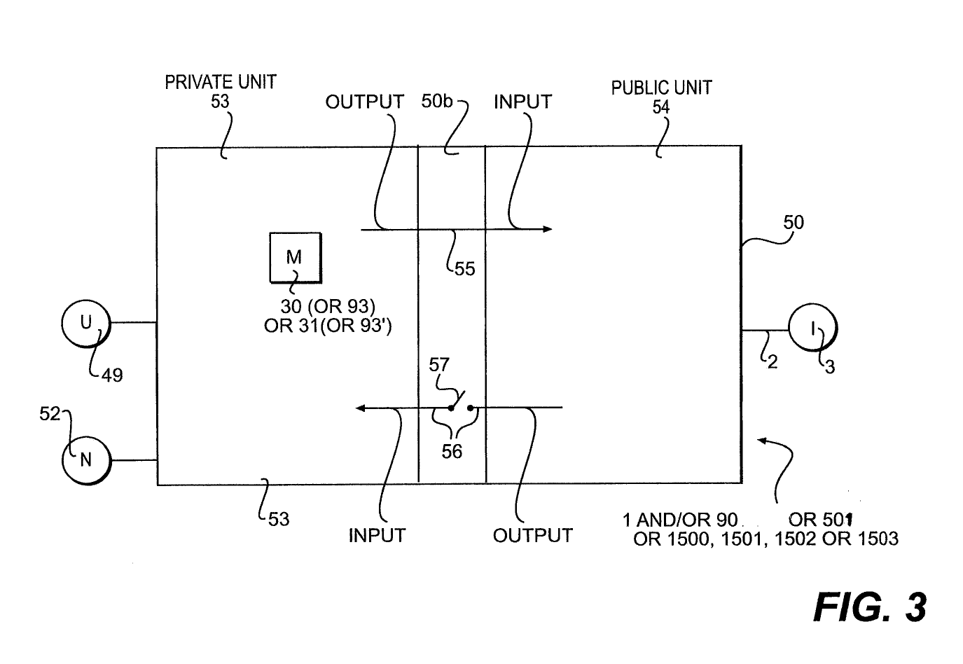

FIG. 3 is a similar useful architectural example embodiment to that shown in FIG. 2, but with the Private Unit 53 and Public Unit 54 connected in terms of communication of data or code by an inner hardware-based firewall or other access barrier 50b example that includes a secure, out-only bus or channel 55 and also includes an in-only bus or channel 56 that is capable of transmitting data or code that is output from the Public Unit 54 to be input into the Private Unit 53, strictly controlled by the master controller 30 (and/or 31 and/or 93 and/or 93′) in the Private Unit 53.

The in-only bus or channel 56 includes an input on/off switch (and/or microchip circuit equivalent) 57 that can break the bus 56 Public to Private connection between Units, the switch 57 being controlled by the Private Unit 53-located master controlling device 30 (or 31 or 93 or 93′), which also controls all traffic on the in-only bus or channel 56; the control can be hardwired.

For one example, the master controller 30 (or 31 or 93 or 93′) can by default use the on/off switch and/or micro-circuit (or nano-circuit) equivalent 57 to break the connection provided by the in-only bus or channel 56 to the Private Unit 53 from the Public Unit 54 whenever the Public Unit 54 is connected to the Internet 3 (or intermediate network 2). In an alternate example, the master controller 30 (or 31 or 93 or 93′) can use the on/off switch and/or micro-circuit equivalent 57 to make the connection provided by the in-only bus or channel 56 to the Private Unit 53 only when very selective criteria or conditions have been met first, so that Public Unit 54 input to the Private Unit 53 is extremely limited and tightly controlled from the Private Unit 53.

An equivalent connection, such as a wireless (including radio and/or optical) connection, to the in-only bus or channel 56 with an input on/off switch 57 between the two Units 53 and 54 would require at least one wireless receiver in the Private Unit 53 and at least one transmitter in the Public Unit 54, so the Private Unit 53 can receive data or code from the Public Unit 54 while controlling that reception of data or code by controlling its receiver, switching it either “on” when the Public Unit 54 is disconnected from external networks 2 and/or 3, for example, or “off” when the Public Unit 54 is connected to external networks 2 and/or 3 (all exclusive of external wireless transmitters or receivers of the PC1 and/or microchip 90 and/or 501).

An architecture for any computer and/or microchip (or nanochip) can have any number of inner hardware-based firewalls or other access barriers 50b arranged in any configuration.

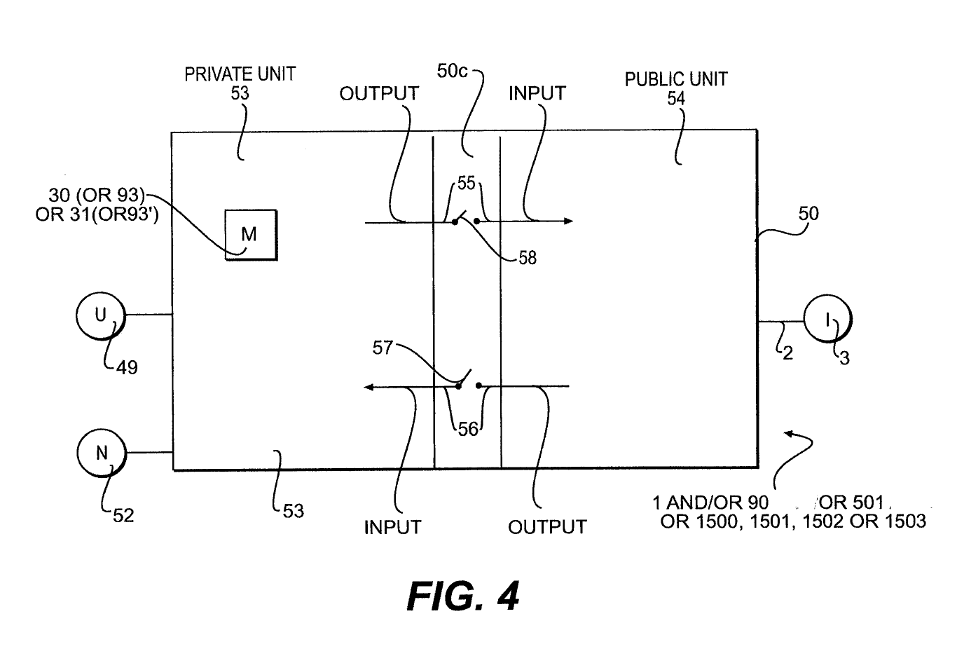

FIG. 4 is a similar useful architectural example embodiment to that shown in FIGS. 2 and 3, but with Private Unit 53 and Public Unit 54 connected in terms of communication of data or code by a hardware-based firewall or other access barrier 50c example that also includes an output on/off switch and/or microcircuit equivalent 58 on the secure out-only bus or channel 55, in addition to the input on/off switch and/or microcircuit (or nano-circuit) equivalent 57 on the in-only bus or channel 56.

The output switch or microcircuit equivalent 58 is capable of disconnecting the Public Unit 54 from the Private Unit 53 when the Public Unit 54 is being permitted by the master controller 30 (or 31 or 93 or 93′) to perform a private operation controlled (completely or in part) by an authorized third party user from the Internet 3, as discussed previously by the applicant relative to FIG. 17D and associated textual specification of the '657 Application incorporated above. The user 49 using the master controller 30 (or 31 or 93 or 93′) always remains in preemptive control on the Public Unit 54 and can at any time for any reason interrupt or terminate any such third party-controlled operation. The master controller 30 (or 31 or 93 or 93′) controls both on/off switches 57 and 58 and traffic (data and code) on both buses or channels 55 and 56 and the control can be hardwired.

An equivalent connection, such as a wireless connection, to the in-only bus or channel 56 and out-only bus or channel 55, each with an on/off switch 57 and 58 between the two Units 53 and 54, would require at least one wireless transmitter and at least one receiver in the Private Unit 53, as well as at least one transmitter and at least one receiver in the Public Unit 54, so the Private Unit 53 can send or receive data or code to or from the Public Unit 54 by directly controlling the “on” or “off” state of its transmitter and receiver, controlling that flow of data or code depending, for example on the state of external network 2 or Internet 3 connection of the Public Unit 54 (again, all exclusive of external wireless transmitters or receivers of the PC1 and/or microchip 90 and/or 501).

An architecture for any computer and/or microchip (or nanochip) can have any number of inner hardware-based firewalls or other access barriers 50c arranged in any configuration.

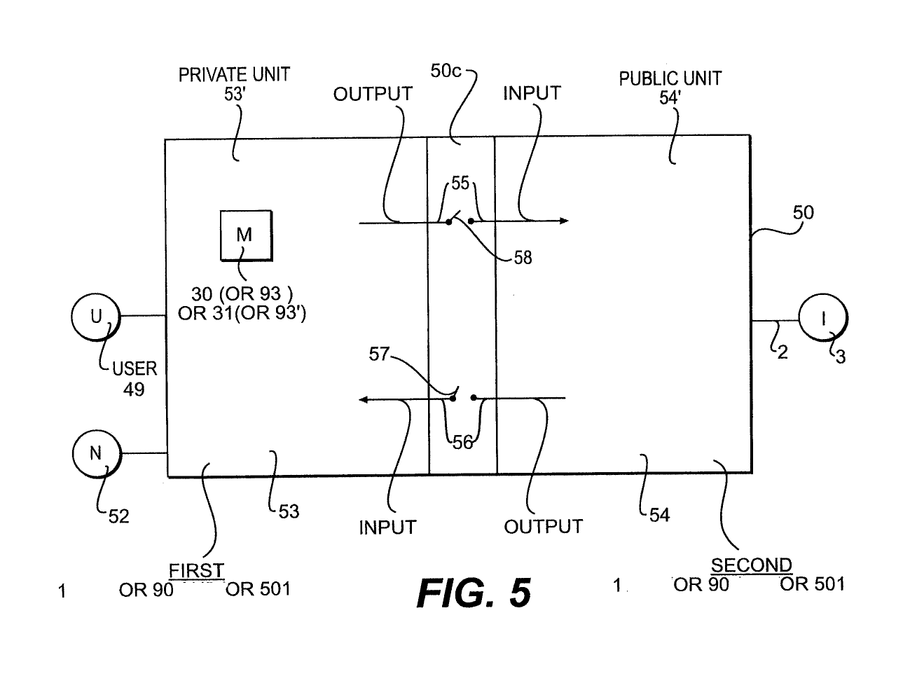

FIG. 5 shows an architectural example embodiment of a first computer (personal computer 1 and/or microchip 90 and/or 501) functioning as a Private Unit 53′ that is connected to at least a second computer (or to a multitude of computers, including personal computers 1 and/or microchips 90 and/or 501) functioning as a Public Unit or Units 54′. The connection between the private computer 53′ and the public computer or computers 54′ is made including the same hardware-based firewall or other access barrier 50c architecture that includes the same buses and channels 55 and 56 with the same on/off switches 57 and 58 as previously described above in the FIG. 4 example above and can use the same hardwire control. Alternatively, hardware-based firewalls or other access barriers 50a or 50b can be used. In addition, hardware-based firewalls or other access barriers 50a, 50b, and 50c can be used within the first and/or second computers.

The connection between the first and second computer can be any connection, including a wired network connection like the Ethernet, for example, or a wireless network connection, similar to the examples described above in previous FIGS. 2-4. In the Ethernet example, either on/off switch 57 or 58 can be functionally replaced like in a wireless connection by control of an output transmitter or an input receiver on either bus or channel 55 or 56; the transmitter or receiver being turned on or off, which of course amounts functionally to mere locating the on/off switches 55 or 56 in the proper position on the bus or channel 55 or 56 to control the appropriate transmitter or receiver, as is true for the examples in previous figures.

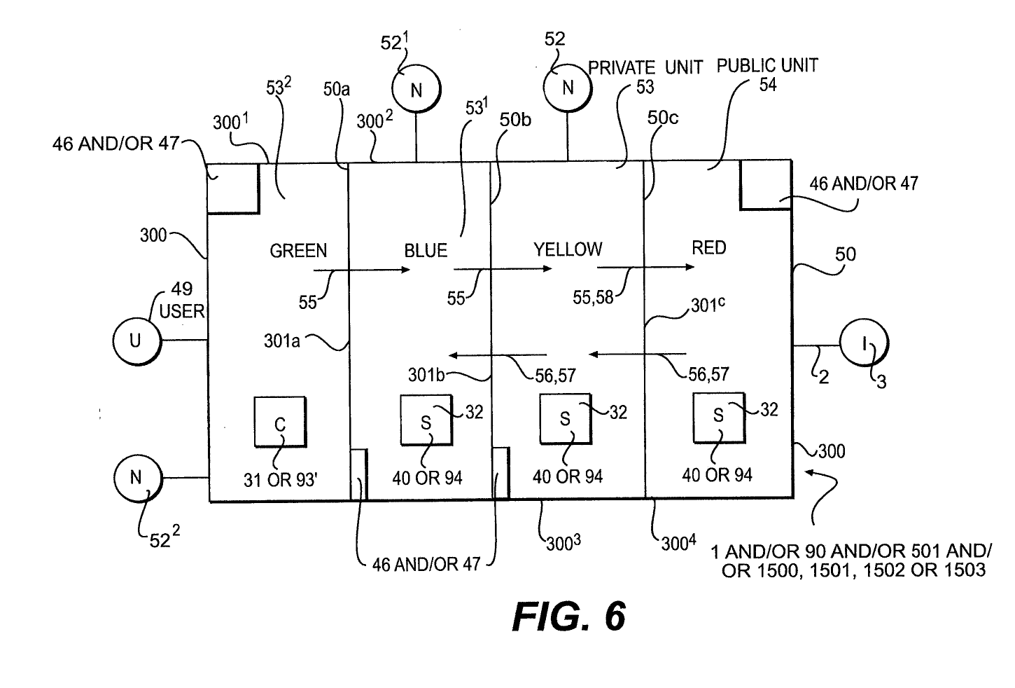

FIG. 6 shows a useful architectural example embodiment of any computer (a personal computer 1 and/or microchip 90 and/or 501) similar to FIGS. 23A and 23B of the '657 Application incorporated by reference above, which showed multiple inner firewalls 50 with progressively greater protection. FIG. 6 shows hardware-based firewalls or other access barriers 50c, 50b, and 50a (described in previous FIGS. 2-4 above) used successively between a public unit 54 and a first private unit 53, between the first private unit 53 and a more private second unit 53¹, and between the more private second unit 53¹ and a most private third unit 53², respectively.

In addition, FIG. 6 shows a useful architectural example embodiment of one or more master controllers-only C (31 or 93′) located in the most private unit 53², with one or more microprocessors or processing units or “cores” S (40 or 94) located in the more private unit 53¹, in the private unit 53, and in the public unit 54.

The microprocessors S (or processing units or cores) can be located in any of the computer units, but the majority in a many core architecture can be in the public unit to maximize sharing and Internet use. Alternatively, for computers that are designed for more security-oriented applications, a majority of the microprocessors S (or processing units or cores) can be located in the private units; any allocation between the public and private units is possible. Any other hardware, software, or firmware component or components can be located in the same manner as are microprocessors S (or master controllers-only C) described above.

An architecture for any computer and/or microchip or nanochip can have any number of hardware-based firewalls or other access barriers 50a and/or 50b and/or 50c arranged in any combination or configuration.

As shown in FIG. 6, the non-Internet network 52, which was discussed previously relative to FIG. 1, can consist in an example embodiment of more than one network, with each additional non-Internet network 52 being used to connect Private Units 53², 53¹, and 53 of one computer and/or microchip to separate non-Internet networks 52², 52¹ and 52, respectively, and that are connected to Private Units 53², 53¹, and 53, respectively, of other computers and/or microchips. That is, each computer and/or microchip Private Unit 53², 53¹, and 53 can have its own separate, non-Internet network 52², 52¹, and 52, respectively, and so that any Private Unit can be connected to other computer PC1 and/or microchip 90 (and/or 501) units of the same level of security; any Private Unit can also be subdivided into subunits of the same level of security. This is a useful embodiment example for making relatively local connections from business or home networks and scales up to large business servers, cloud, or supercomputers applications. The connections can be wired or wireless and local or non-local. Similarly, a computer PC1 and/or microchip 90 or 501 Public Unit 54 can be subdivided into a number of different levels of security, for example, and each subdivided Public Unit 54 can have a separate, non-Internet connected network 52; and a subdivided Public Unit 54 can be further subdivided with the same level of security. In addition, any hardware component (like a hard drive or Flash memory device (and associated software or firmware), within a private (or public) unit of a given level of security can be connected by a separate non-Internet network 52 to similar components within a private (or public) unit of the same level of security.

Also shown in the example embodiment of FIG. 6, each Private Unit 53², 53¹, and 53 can have one or more ports (or connections to one or more ports), like for a USB connection to allow for the use of one or more optional removable access and/or encryption or other keys 46, and/or one or more optional removable memory (such as a USB Flash memory thumbdrive) or other device 47, both of which as discussed previously in the text of FIG. 1, which example can also have one or more ports for either 46 and/or 47 and/or other device. The Public Unit 54 can also have one or more of any such removable devices, or ports like a USB port to allow for them.

Any data or code or system state, for example, for any Public or Private Unit 54 or 53 can be displayed to the personal user 49 and can be shown in its own distinctive color or shading or border (or any other visual or audible distinctive characteristic, like the use of flashing text). FIG. 6 shows an example embodiment of different colors indicated for each of the Units.

For embodiments requiring a higher level of security, it may be preferable to eliminate permanently or temporarily block (by default or by user choice, for example) the non-Internet network 52² and all ports or port connections in the most private unit 53².

The public unit 54 can be subdivided into an encrypted area (and can include encryption/decryption hardware) and an open, unencrypted area, as can any of the private units 53; in both cases the master central controller 30, 31, 93, or 93′ can control the transfer of any or all code or data between an encrypted area and an unencrypted area.

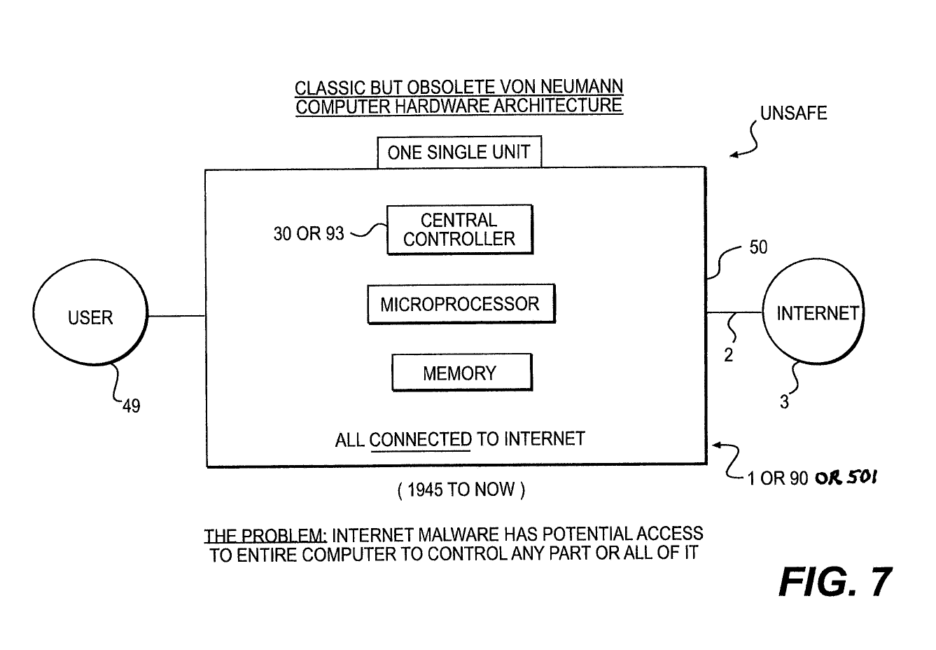

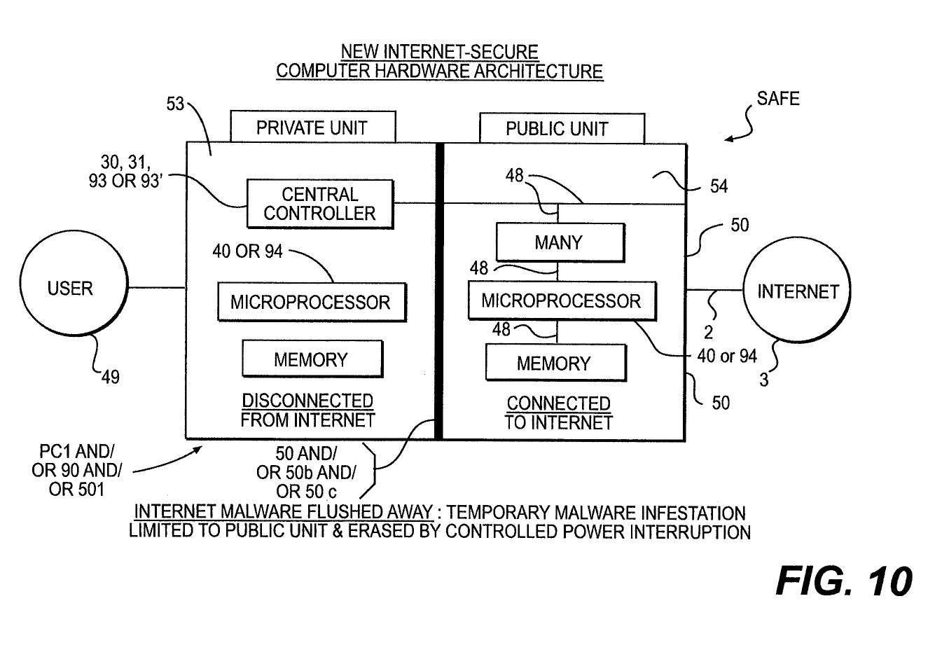

The invention example structural and functional embodiments shown in the above described FIGS. 1-6, as well as the following FIGS. 7-14 and the associated textual specification of this application all most directly relate to the example structural and functional embodiments of the inner firewall 50 described in FIGS. 10A-10D, 10J-10Q, 17A-17D, 23A-23E, 24, 25A-25D and 27A-27G, and associated textual specification, of the above '657 Application incorporated by reference.

FIGS. 7-14 are useful architectural example embodiments of the hardware-based firewalls or other access barriers 50a, 50b, and 50c.

FIG. 7 shows the fundamental security problem caused by the Internet connection to the classic Von Neumann computer hardware architecture that was created in 1945. At that time there were no other computers and therefore no networks of even the simplest kind, so network security was not a consideration in its fundamental design.

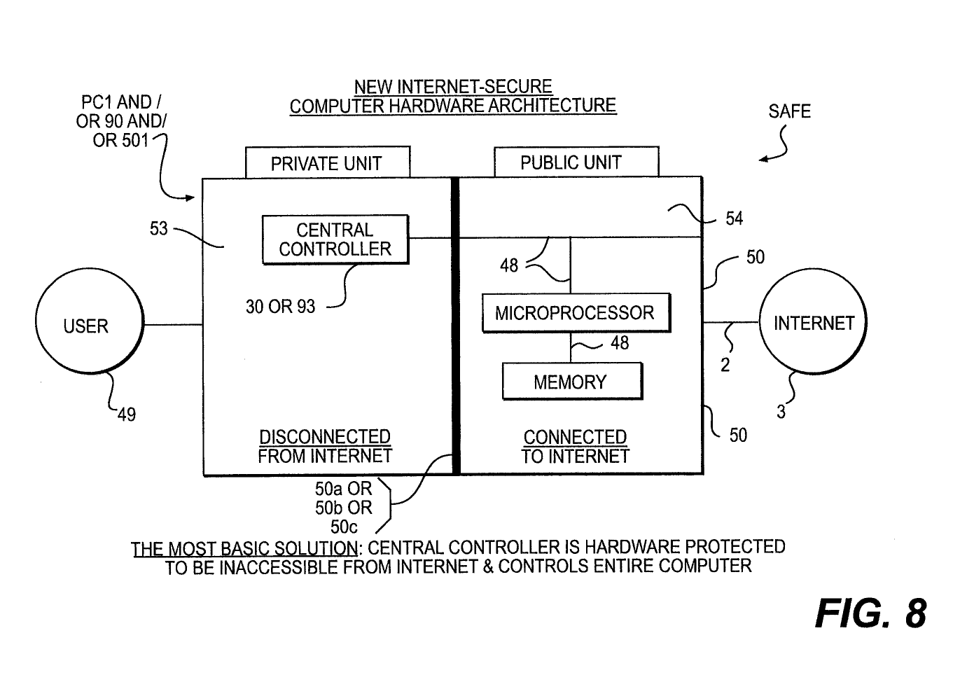

FIG. 8 shows a useful example embodiment of the applicant's basic architectural solution to the fundamental security problem caused by the Internet, the solution being to protect the central controller of the computer with a no-Internet-access inner firewall 50, as discussed in detail in FIGS. 10A-10D and 10J-10Q, and associated textual specification of the '657 Application incorporated by reference, as well as earlier in this application. FIG. 8 and subsequent figures describe example embodiments of a number of specific forms of a hardware-based firewall or other access barrier 50, such as firewalls or other access barriers 50a and/or 50b and/or 50c as described previously in this application; the number and potential configurations of firewalls or other access barriers 50a and/or 50b and/or 50c within any computer, such as computer PC 1 and/or microchip 90 (and/or 501) is without any particular limit.

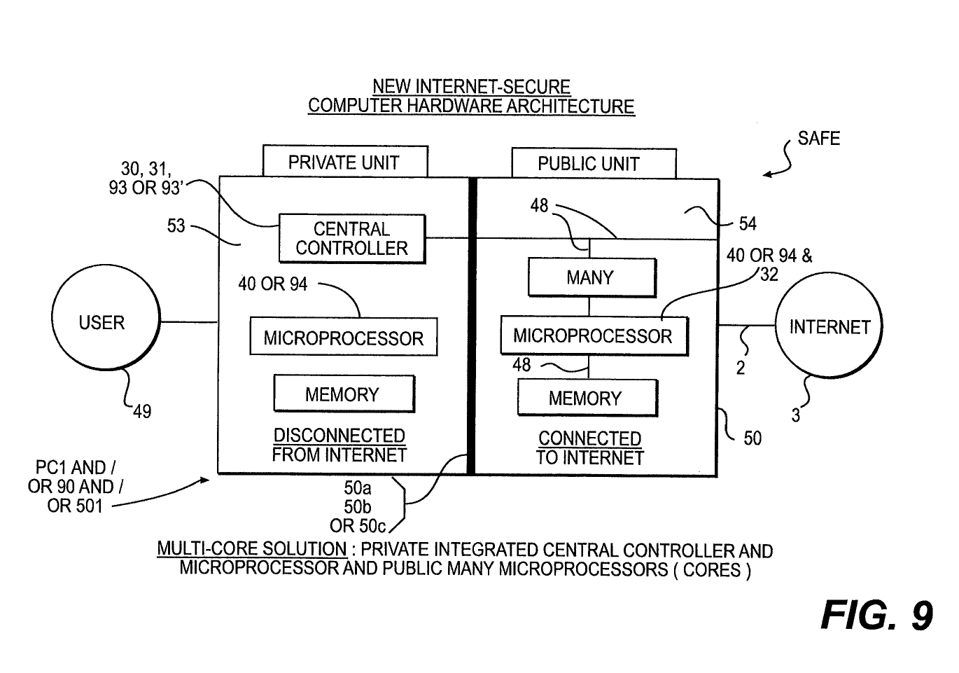

FIG. 9 is a similar embodiment to FIG. 8, but also showing a useful architectural example of a central controller integrated with a microprocessor to form a conventional general purpose microprocessor or CPU (like an Intel x86 microprocessor, for example). FIG. 8 also shows a computer PC1 and/or microchip 90 and/or 501 with many microprocessors or cores.

FIG. 10 is the same embodiment as FIG. 9, but also shows a major functional benefit of the applicant's firewall or other access barrier 50a, 50b, and 50c invention, which is to enable a function to flush away Internet malware by limiting the memory access of malware to DRAM 66 (dynamic random access memory) in the Public Unit 54, which is a useful example of a volatile memory that can be easily and quickly erased by power interruption. The flushing function of a firewall 50 was discussed earlier in detail in FIGS. 25A-25D and associated textual specification of the '657 Application incorporated by reference earlier.

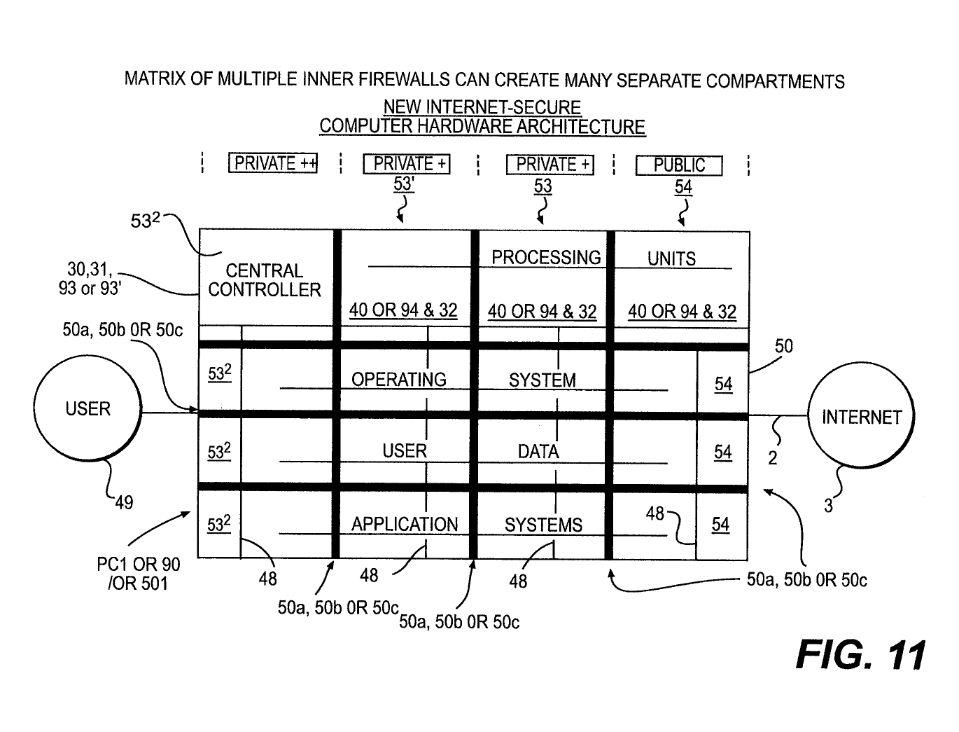

FIG. 11 is a useful example embodiment similar to FIG. 6 and shows that any computer or microchip can be partitioned into many different layers of public units 54 and private units 53 using an architectural configuration of firewalls or other access barriers 50a, 50b, and 50c; the number and arrangement of potential configurations is without any particular limit. The partition architecture provided by firewalls 50 was discussed earlier in detail in FIGS. 23A-23B and associated textual specification of the '657 Application incorporated by reference earlier.

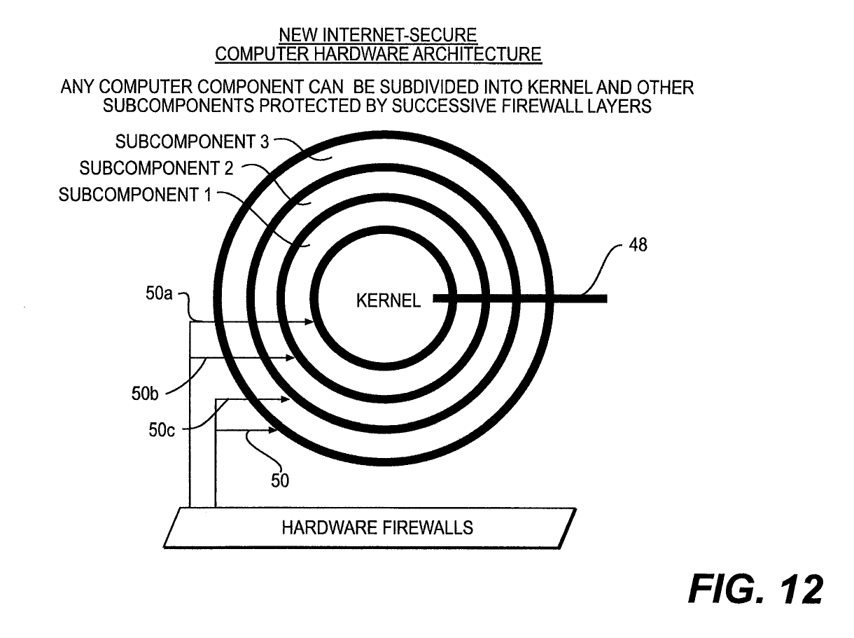

FIG. 12 is another useful architectural example embodiment of the layered use of firewalls or other access barriers 50, 50c, 50b, and 50c based on a kernel or onion structure; the number of potential configurations is without any particular limit. This structure was discussed in detail relative to firewalls 50 in FIGS. 23D-23E and associated textual specification of the '657 Application incorporated by reference earlier.

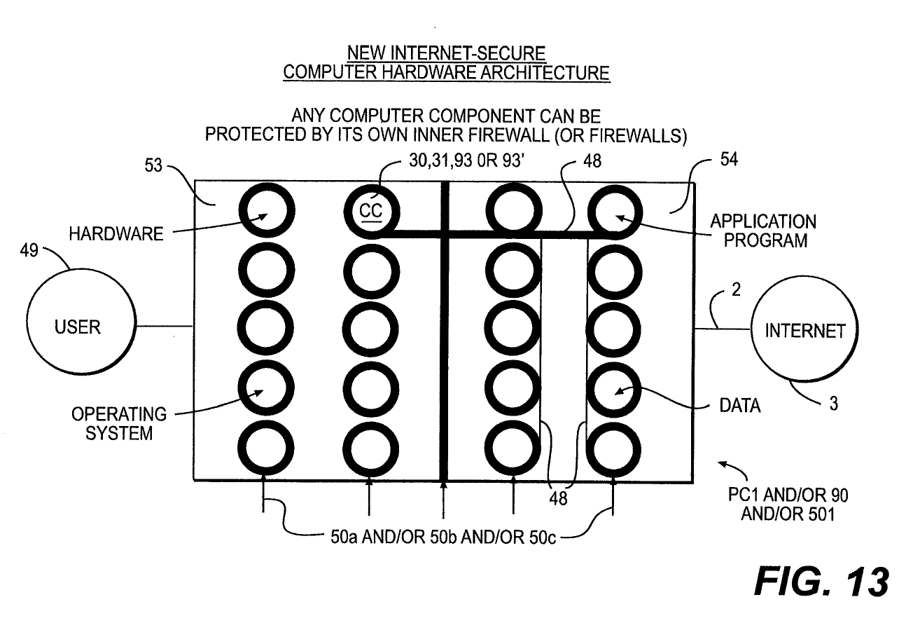

FIG. 13 is a useful architectural example embodiment showing the presence of many FIG. 12 layered firewall or other access barriers 50a, 50b, and 50c structures on any of the many hardware, software, and/or firmware components of a computer; the number of potential configurations is without any particular limit. The many layered kernels structure was discussed in more detail in FIG. 23C and associated textual specification of the '657 Application incorporated by reference earlier.

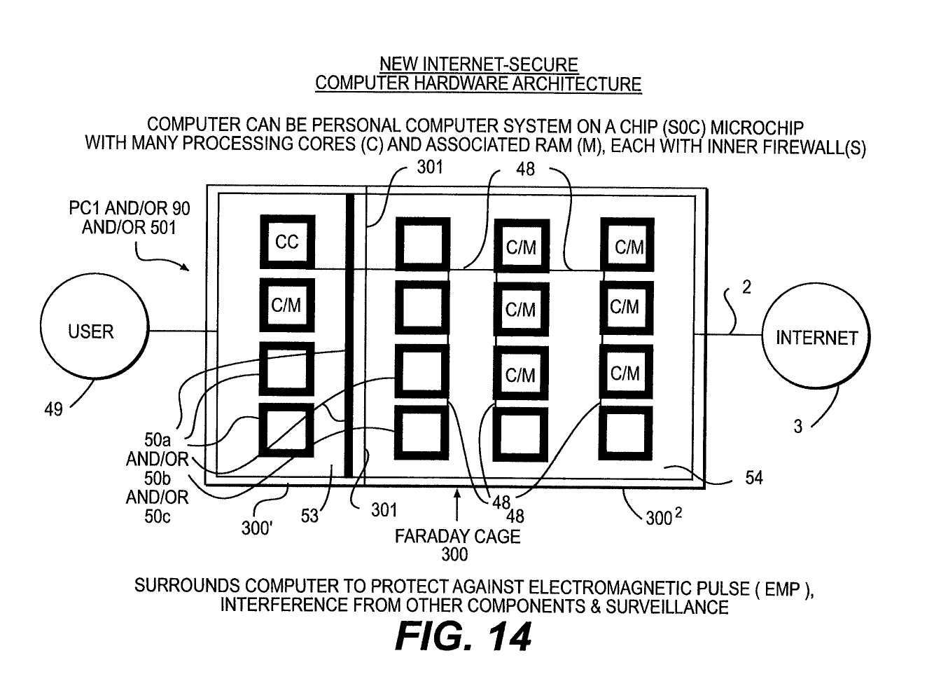

FIG. 14 is a useful architectural example embodiment similar to FIG. 13, but also showing the computer PC1 and/or microchip 90 and/or 501 surrounded by a Faraday Cage 300; the number of potential similar configurations is without any particular limit. This use of Faraday Cages 300 was discussed in detail in FIGS. 27A-27G and associated textual specification of the '657 Application incorporated by reference earlier.

FIG. 14 shows a useful example embodiment of a Faraday Cage 300 surrounding completely a computer PC1 and/or microchip 90 and/or 501. The Faraday Cage 300 can be subdivided by an example partition 301 to protect and separate the Private Unit 53 from the Public Unit 54, so that the Private Unite 53 is completely surrounded by Faraday Cage 300¹ and Public Unit 54 is completely surrounded by Faraday Cage 300², in the example embodiment shown. Each unit can alternatively have a discrete Faraday Cage 300 of its own, instead of partitioning a larger Faraday Cage 300 and the surrounding of a Unit can be complete or partial. Any number or configuration of Faraday Cages can be used in the manner shown generally in FIG. 14, including a separate Faraday Cage for any hardware component of the computer or microchip.

The example embodiments shown in FIGS. 1-4, 6-11, and 13-14 are a computer of any sort, including a personal computer PC1; or a microchip 90 or 501, including a microprocessor or a system on a chip (SoC) such as a personal computer on a microchip 90; or a combination of both, such as a computer with the architecture shown in FIGS. 1-4, 6-11, and 13-14, the computer also including one or more microchips also with the architecture shown in FIGS. 1-4, 6-11, and 13-14.

The Public Unit 54 shown in FIGS. 1-6, 8-11, and 13-14 can be used in a useful embodiment example to run all or a part of any application (or “apps”) downloaded from the Internet or Web, such as the example of any of the many thousands of apps for the Apple iPhone that are downloaded from the Apple Apps Store, or to run applications that are streamed from the Internet or Web. Similarly, all or part of a video or audio file like a movie or music can be downloaded from the Web and played in the Public Unit 54 for viewing and/or listening be the computer user 49.

Some or all personal data pertaining to a user 49 can be kept exclusively on the user's computer PC1 and/or microchip 90 and/or 501 for any cloud application or app to protect the privacy of the user 49 (or kept non-exclusively as a back-up), unlike conventional cloud apps, where the data of a personal user 49 is kept in the cloud and potentially intentionally shared or carelessly compromised without authorization by or knowledge of the personal user 49. In effect, the Public Unit 54 can be a safe and private local cloud, with personal files retained there or in the Private Unit 53. All or part of an app can also potentially be downloaded or streamed to one or more Private Units, including 53², 53¹, and 53.

Privacy in conventional clouds can also be significantly enhanced using the hardware-based firewalls and/or other access barriers 50a and/or 50b and/or 50c described in this application, since each individual or corporate user of the cloud can be assured that their data is safe because it can be physically separated and segregated by hardware, instead of by software alone, as is the case currently.

Similarly, the example embodiment of FIG. 6 shows a computer and/or microchip Public Unit 54 and Private Units 53, 53¹, and 53², each with a separate Faraday Cage. 300⁴, 300³, 300², and 300¹, respectively, that are create using partitions 301^{c}, 301^{b}, and 301^{a}, respectively. Any Public Unit 54 or Private Unit 53 can be protected by its own Faraday Cage 300. The Faraday Cage 300 can completely or partially surround the any Unit in two or three dimensions.

FIGS. 8-11 and 13-14 also show example embodiments of a secure control bus (or wire or channel) 48 that connects the master controlling device 30 (or 31) or master control unit 93 (or 93′) or central controller (as shown) with the components of the computer PC1 and/or microchip 90 and/or 501, including those in the Public Unit 54. The secure control bus 48 provides hardwired control of the Public Unit 54 by the central controller in the Private Unit 53. The secure control bus 48 can be isolated from any input from the Internet 3 and/or an intervening other network 2 and/or from any input from any or all parts of the Public Unit 54. The secure control bus 48 can provide and ensure direct preemptive control by the central controller over any or all the components of the computer, including the Public Unit 54 components. The secure control bus 48 can, partially or completely, coincide or be integrated with the bus 55, for example. The secure control bus 48 is configured in a manner such that it cannot be affected, interfered with, altered, read or written to, or superseded by any part of the Public Unit 54 or any input from the Internet 3 or network 2, for example. A wireless connection can also provide the function of the secure control bus 48 a manner similar to that describing wireless connections above in FIGS. 2-6 describing buses 55 and 56.

The secure control bus 48 can also provide connection for the central controller to control a conventional firewall or for example firewall or other access barrier 50c located on the periphery of the computer or microchip to control the connection of the computer PC1 and/or microchip 90 and/or 501 to the Internet 3 and/or intervening other network 2.

The secure control bus 48 can also be used by the master central controller 30, 31, 93, or 93′ to control one or more secondary controllers 32 located anywhere in the computer PC1 and/or microchip 90 and/or 501, including in the Public Unit 54 that are used, for example, to control microprocessors or processing units or cores S (40 or 94) located in the Public Unit 54. The one or more secondary controllers 32 can be independent or integrated with the microprocessors or processing units or cores S (40 or 94) shown in FIGS. 9 and 11 above, for example; such integrated microprocessors can be specially designed or general purpose microprocessors like an Intel x86 microprocessor, for example.

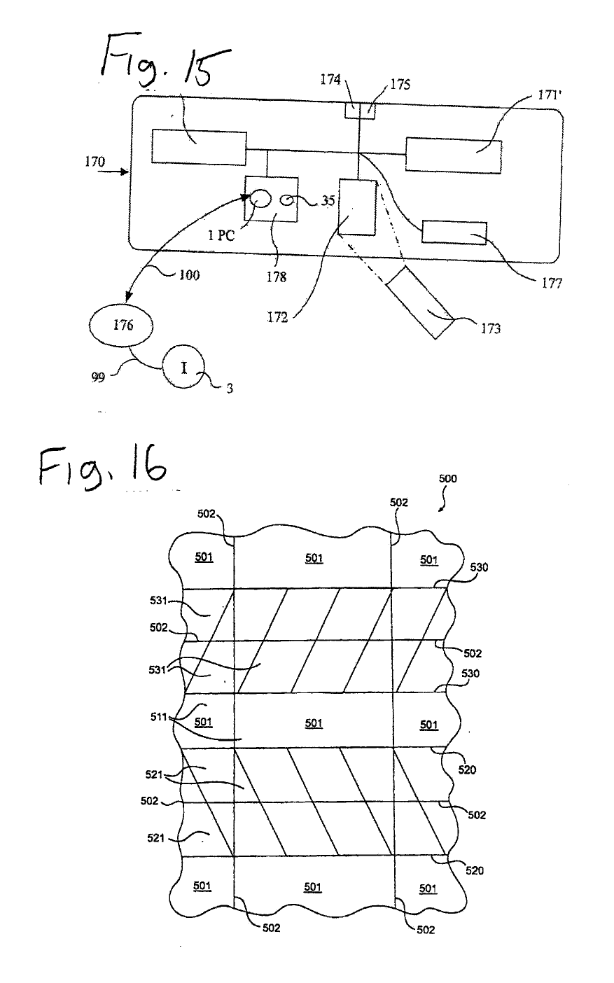

FIGS. 15-16 are copies of the cover pages of the patent applications '657 and '769 that are incorporated by reference in their entirety in this application.

Any one or more features or components of FIGS. 1-14 of this application can be usefully combined with one or more features or components of FIGS. 1-31 of the above '657 U.S. Application or FIGS. 1-27 of the above '769 U.S. Application. Each of the above '657 and '769 Applications and their associated U.S. publications are expressly incorporated by reference in its entirety for completeness of disclosure of the applicant's combination of one or more features or components of either of those above two prior applications of this applicant with one or more features or components of this application. All such useful possible combinations are hereby expressly intended by this applicant.

Furthermore, any one or more features or components of FIGS. 1-14 of this application can be usefully combined with one or more features or components of the figures of the above '049 and '553 U.S. Applications, as well as in the above '428, '250, '141, '449, '906, '275, '020, '854, '529, '756, and '233 U.S. patents. Each of the above '049 and '553 Applications and their associated U.S. publications, as well as the above '428, '250, '141, '449, '906, '275, '020, '854, '529, '756, and '233 U.S. patents are expressly incorporated by reference in its entirety for completeness of disclosure of the applicant's combination of one or more features or components of either of those above two prior applications of this applicant with one or more features or components of this application. All such useful possible combinations are hereby expressly intended by this applicant.

In addition, one or more features or components of any one of FIGS. 1-14 or associated textual specification of this application can be usefully combined with one or more features or components of any one or more other of FIGS. 1-14 or associated textual specification of this application. And any such combination derived from the figures or associated text of this application can also be combined with any feature or component of the figures or associated text of any of the above incorporated by reference U.S. Applications '657, '769, '049, and '553, as well as U.S. Pat. Nos. '428, '250, '141, '449, '906, '275, '020, '854, '529, '756, and '233.

1. I claim the hardware or firmware-based firewalls or other access barriers 50a, 50b, and 50c as shown in FIGS. 2, 3, 4, and 6 above, as well as in FIGS. 8-14 above, and as described in the associated textual specification above, and any useful combinations of any features or components of any one of said firewalls with any feature or component of another (or both) of said firewalls, or any other combination with a feature or component of embodiments described in any of the U.S. patents or applications incorporated by reference in this application.
